(19) United States
(12) Patent Application Publication
(10) Pub. No.: US 2006/0186661 A1
(43) Pub. Date: Aug. 24, 2006

(54) Gladhand grip

(75) Inventor: David J. Levan, North Collins, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Tectran Mfg. Inc.

(21) Appl. No.: 11/359,113

(22) Filed: Feb. 22, 2006

Related U.S. Application Data
(60) Provisional application No. 60/655,197, filed on Feb. 22, 2005.

(51) Int. Cl. F16L 13/04

(52) U.S. Cl. 285/114

(57) ABSTRACT

A gladhand grip device (10) is adapted to be attached to one portion (11) of a gladhand coupling and to surround a marginal end portion of a hose (H) connected to the coupling portion to allow an operator to more easily apply a torque to the coupling portion when connecting or disconnecting the coupling and to protect the hose marginal end portion against acute flexure. The device includes: an adapter (12) having a first threaded portion (20) adapted to matingly engage the coupling portion; and a handle assembly (13) surrounding the hose marginal end portion and having a first end and a second end, a marginal portion of the handle assembly about the first end being adapted to be selectively attached to the adapter, the handle portion being so dimensioned and configured that its transverse flexural resistance progressively decreases in a direction from the first end toward the second end; such that an operator may grasp the relatively-rigid portion of the handle assembly proximate the first end and may apply a torque to the coupling portion when connecting or disconnecting the coupling, while the progressively-variable flexural resistance of the handle assembly along its length protects the hose marginal end portion from flexing acutely.

### TECHNICAL FIELD

The present invention relates generally to gladhand couplings that are used to connect the air lines between a tractor and trailer, and, more particularly, to an improved gladhand grip that is adapted to be attached to one portion of a gladhand coupling and to surround a marginal end portion of a hose connected to the coupling portion to allow an operator to more easily apply a torque to the coupling portion when connecting or disconnecting the coupling, and, further, to protect the hose marginal end portion against acute flexure.

### BACKGROUND ART

A gladhand coupling generally refers to the separable connection between the air lines of a tractor and trailer. These couplings generally have one half that is attached to the tractor, and another trailer-mounted half that is adapted to be selectively joined to, and disconnected from, the tractor-mounted half.

When a trailer is to be disconnected from its tractor, the gladhand coupling is disconnected.

When a trailer is to be connected to its tractor, the gladhand coupling is connected so that the pneumatic air lines on the tractor can communicate with the trailer's brakes.

In connecting or disconnecting the coupling halves, the operator must typically apply a torque to the movable coupling half. Since torque is a force applied at an arm distance, the greater the arm distance, the smaller the needed force to produce the same torque. In other words, an operator can apply the same torque by exerting a smaller force at a greater arm distance.

At the same time, it would be desirable to protect the marginal end portion of the air line adjacent the gladhand coupling against acute flexure.

### DISCLOSURE OF THE INVENTION

With parenthetical reference to the corresponding parts, portions or surfaces of the disclosed embodiment, merely for purposes of illustration and not by way of limitation, the present invention broadly provides an improved device (10) that is adapted to be attached to one portion (11) of a gladhand coupling and to surround a marginal end portion of a hose (H) connected to the coupling portion to allow an operator to more easily apply a torque to the coupling portion when connecting or disconnecting the coupling and to protect the hose marginal end portion against acute flexure.

The improved device broadly includes: a handle assembly (13) surrounding the hose marginal end portion and having a first end (35) and a second end (36), a marginal portion of the handle assembly about the first end being adapted to be selectively attached to the coupling portion, the handle portion being so dimensioned and configured that its transverse flexural resistance progressively decreases in a direction from the first end toward the second end; whereby an operator may grasp the relatively-rigid portion of the handle assembly proximate the first end and may apply a torque to the coupling portion when connecting or disconnecting the coupling, while the progressively-variable flexural resistance of the handle assembly along its length protects the hose marginal end portion from flexing acutely.

In the preferred embodiment, an adapter (12) is mounted on the coupling portion, and the handle assembly includes a base (14) and a sleeve (15). The base is adapted to be attached to the adapter. The base may be formed of brass, and the sleeve may be formed of a resilient thermoplastic material, such as Santoprene® (such material is a registered trademark of, and is available from, Monsanto Company, 800 North Lindbergh Blvd., St. Louis, Mo. 63166, or Advanced Elastomer Systems, 388 South Main Street, Akron, Ohio 44311), which is preferably overmolded onto the base.

The sleeve may have a tapered outer surface, or a tapered wall for a portion of its longitudinal extent. This tapered wall may include two consecutive tapered portions. In the preferred embodiment, the tapered wall portion has a first taper (39) of about 7° extending away from the first end, and a second taper (40) of about 3° continuing toward the second end.

The base may have an alternating series of lands (32) and grooves (33), and may have a polygonal outer surface

Accordingly, the general object of this invention is to provide an improved device that is adapted to be attached to one portion of a gladhand coupling to allow an operator to more easily apply a torque to the coupling portion when connecting or disconnecting the coupling.

Another object is to provide an improved device that is adapted to surround a marginal end portion of a hose adjacent the coupling, and which has a progressively decreasing resistance to transverse flexure as one proceeds away from the coupling to protect the hose marginal end portion against acute flexure.

These and other objects and advantages will become apparent from the foregoing and ongoing written specification, the drawings, and the appended claims.

### BRIEF DESCRIPTION OF THE DRAWINGS

FIG. 1 is a side elevation of the improved device, shown in association with a sectional portion of a gladhand coupling portion.

FIG. 2 is a longitudinal vertical sectional view thereof, taken generally on line 2-2 of FIG. 1.

FIG. 3 is an axially-exploded aligned sectional view of the device shown in FIG. 2.

FIG. 4 is a view, similar to FIG. 4, but showing a hose as being secured to the base, and the sleeve as surrounding a marginal end portion thereof.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up”, “down”, “clockwise” and “counter-clockwise”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

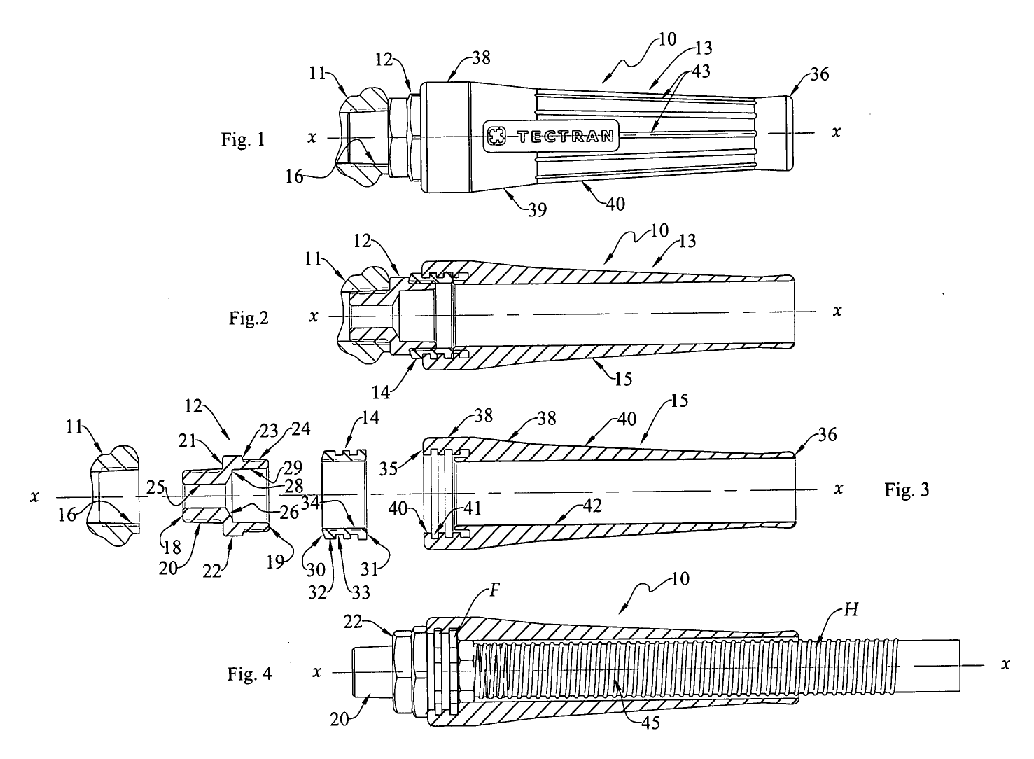

Referring now to the drawings, and, more particularly, to FIGS. 1-3 thereof, the present invention broadly provides an improved gladhand grip device, generally indicated at 10, that is adapted to be attached to one portion of a gladhand coupling, fragmentarily indicated at 11. The improved device is adapted to surround the marginal end portion of a hose, such as indicated at H in FIG. 4, that is connected to the gladhand coupling portion to allow an operator to more easily apply a torque to the coupling portion when connecting or disconnecting the coupling, and to protect the hose marginal end portion against acute flexure.

The device is shown as broadly including an adapter, generally indicated at 12, and a handle assembly, generally indicated at 13. More particularly, the handle assembly is shown as including a base 14, and an overmolded thermoplastic sleeve, generally indicated at 15.

In the accompanying drawing figures, the gladhand portion 11 is depicted fragmentarily. Such gladhand couplings, and the various portions thereof, are well-known in this art. Suffice it to say that the gladhand has an internally-threaded recess 16 into which the adapter may be threaded.

As best shown in FIG. 4, adapter 12 is a specially-configured horizontally-elongated tubular member having an annular vertical left end face 18, an annular vertical right end face 19, an outer surface that sequentially includes (from left to right): an externally-threaded portion 20 extending rightwardly from the outer margin of left end face 18, a leftwardly-facing annular vertical surface 21, an outwardly-facing horizontal polygonal surface 22, a shallow rightwardly-facing annular vertical shoulder 23, and an externally-threaded portion 24 continuing rightwardly therefrom to join the outer margin of right end face 19. The adapter is shown as also having a stepped axial through-bore that sequentially includes (in pertinent part): a horizontal cylindrical surface 25 extending rightwardly from the inner margin of left end face 18, a rightwardly—and inwardly-facing frusto-conical surface 26, the rightwardly-facing annular vertical surface 28, and an internally-threaded portion 29 continuing rightwardly therefrom to join the inner margin of right end face 19. The adapter may preferably be formed of a suitable material, such as brass.

Still referring principally to FIG. 3, base 14 is also shown as being a specially-configured horizontally-elongated tubular member having a leftwardly- and outwardly-facing frusto-conical left end face 30, an annular vertical right end face 31, and an outer surface consisting of a plurality of alternating annular lands 32 and grooves 33 extending between the outer margins of the left and right end faces. The base is shown as having an internally-threaded through-bore 34, which adapted to matingly engage adapter threaded portion 24. Here again, the base may be formed of a suitable metal, such as brass.

Continuing to refer principally to FIG. 3, the sleeve is shown as being a one-piece horizontally-elongated specially-configured tubular member. More particularly, sleeve 15 has an annular vertical left end face 35, a convex or rounded annular right end face 36, and an outer surface that sequentially includes a horizontal cylindrical portion 38 extending rightwardly from the outer margin of left end face 35, an outwardly- and rightwardly-facing frusto-conical portion 39, another rightwardly—and outwardly-facing frusto-conical portion 40 continuing rightwardly therefrom, and joining the left margin of convex right end face 36. Frusto-conical surfaces 39, 40 are contiguous to one another, and are arranged at acute included angles of 7° and 3°, respectively, with respect to a line parallel to the longitudinal axis x-x. The sleeve portion is shown as having a through-bore that sequentially includes a plurality of alternating lands 40 and grooves 41 adjacent the left end face. These lands and grooves are adapted to fit into the complimentary-configured grooves 33 and lands 32 of adapter 14. The sleeve is also shown as having an inner horizontal cylindrical surface 42 extending rightwardly from the lands-and-grooves portion to join the inner margin of right end face 36. In the preferred embodiment, the sleeve is formed of a suitable resilient thermal plastic material, such as Santroprene®. In the preferred embodiment, the sleeve member is molded on the adapted, on the complimentary lands and grooves serving to interdigitally lock the two members together.

As best shown in FIG. 1, the sleeve portion may include a plurality of circumferentially-spaced elongated ribs, generally indicated at 43.

The device is assembled as shown in FIG. 2. More particularly, the adapter 12 is first threaded into engagement with the pertinent portion of the gladhand coupling half. As best shown in FIG. 4, a hose, having an appropriate fitting F at its left end, may then be threaded into engagement with threaded portion 29 of the adapter. Thereafter, the handle assembly 13 may be slid along the hose, and base inner surface 34 may be threaded into engagement with adapter outer surface 24.

The sleeve portion 15 of the handle assembly is uniquely configured. It allows an operator to grasp the thickened portion toward the left marginal end portion of the sleeve and to more easily apply a torque to the coupling portion when connecting or disconnecting the coupling. At the same time, the progressively-decreasing cross-sectional configuration of the sleeve, as one proceeds from left to right in FIG. 4, allows the sleeve to have a progressively decreasing transverse flexural resistance as one approaches its rightward end. This then prevents acute flexure of the hose marginal end portion 45.

Therefore, the invention broadly provides an improved device 10 that is adapted to be attached to one portion of a gladhand coupling and to surround a marginal end portion of a hose H connected to the coupling portion to allow an operator to more easily apply a torque to the coupling portion when connecting or disconnecting the coupling and to protect the hose marginal end portion against acute failure. The improved device broadly includes an adapter 12 having a first threaded portion adapted to matingly engage the coupling portion; and a handle assembly 1 surrounding the hose marginal end portion and having a first end and a second end, a marginal portion of the handle assembly about the first end being adapted to be selectively attached to the adapter, the handle portion being so dimensioned and configured that its transverse flexural resistance progressively decreases in a direction from a first end toward the second end; such that an operator may grasp the relatively-rigid portion of the handle proximate the first end and may apply a torque to the coupling portion when connecting or disconnecting the coupling, while the progressively-variable flexural resistance of the handle assembly along its length protects the hose marginal end portion from flexing acutely.

### Modifications

The present invention expressly contemplates that many changes and modifications may be made. For example, the shape and configuration of the various parts may be changed, as desired. While it is presently preferred to form the adapter and base of brass, this is not invariable. Other materials might be substituted therefore. Similarly, while it is presently preferred to use Santoprene® as the material for the handle assembly, this too may be changed. The sleeve may not be overmolded onto the base. Rather, in some other configuration, it might be mechanically connected thereto, as by the alternating series of lands and grooves being a course screw thread.

Therefore, while the presently preferred form of the improved gladhand grip device has been shown and described, and several modifications thereof discussed, persons skilled in this art will readily appreciate that various additional changes and modifications may be made without departing from the spirit of the invention, as defined and differentiated by the following claims.

What is claimed is:

1. A device adapted to be attached to one portion of a gladhand coupling and to surround a marginal end portion of a hose connected to said coupling portion to allow an operator to more easily apply a torque to said coupling portion when connecting or disconnecting the coupling and to protect said hose marginal end portion against acute flexure, comprising:
a handle assembly surrounding said hose marginal end portion and having a first end and a second end, a marginal portion of said handle assembly about said first end being adapted to be selectively attached to said coupling portion, said handle portion being so dimensioned and configured that its transverse flexural resistance progressively decreases in a direction from said first end toward said second end;
whereby an operator may grasp the relatively-rigid portion of said handle assembly proximate said first end and may apply a torque to said coupling portion when connecting or disconnecting said coupling, while the progressively-variable flexural resistance of said handle assembly along its length protects said hose marginal end portion from flexing acutely.

2. A device as set forth in claim 1 wherein said handle assembly includes a base and a sleeve.

3. A device as set forth in claim 2 wherein said base is adapted to be attached to said coupling portion.

4. A device as set forth in claim 2 wherein said base is formed of brass.

5. A device as set forth in claim 2 wherein said sleeve is formed of a resilient material.

6. A device as set forth in claim 2 wherein said sleeve is molded on said base.

7. A device as set forth in claim 2 wherein said sleeve has a tapered outer surface.

8. A device as set forth in claim 2 wherein said sleeve has a tapered wall for a portion of its longitudinal extent.

9. A device as set forth in claim 8 wherein said tapered wall portion has a first taper of about 7° extending away from said first end, and a second taper of about 3° continuing toward said second end.

10. A device as set forth in claim 2 wherein said base has an alternating series of lands and grooves.

11. A device as set forth in claim 2 wherein a portion of said base has a polygonal outer surface.

12. A device as set forth in claim 1, and further comprising:
an adapter having a first threaded portion adapted to matingly engage said coupling portion, and having a second threaded portion, and wherein said handle assembly is adapted to be threaded onto said adapter.
